(19) United States
(12) Patent Application Publication
(10) Pub. No.: US 2009/0237712 A1
(43) Pub. Date: Sep. 24, 2009

(54) IMAGE FORMING APPARATUS

(76) Inventor: Junichi SHIRAI, Osaka (JP)

Correspondence Address: OSTROLENK FABER GERB & SOFFEN, 1180 AVENUE OF THE AMERICAS, NEW YORK, NY, 100368403, US

(21) Appl. No.: 12/360,401

(22) Filed: Jan. 27, 2009

(30) Foreign Application Priority Data
Mar. 24, 2008 (JP) 2008-75113

(51) Int. Cl. H04N 3/27; H04N 1/04

(52) U.S. Cl. 358/1.15; 358/474; 715/274

(57) ABSTRACT

An image forming apparatus includes an operation unit that accepts an operation instruction; a printing unit that prints a document image on an image forming medium in accordance with the accepted operation instruction; a print-preview-image generating unit that generates a print preview image of the document image; a display unit that displays on a display screen the print preview image of the document image and an image of a medium frame showing edges of the image forming medium, the print preview image being superimposed on the image of the medium frame; and a control unit that, when a print preview image frame of the document image displayed on the display screen is operated to be moved, enlarges/reduces the print preview image of the document image in accordance with the amount of displacement of the print preview image frame and displays the enlarged/reduced print preview image.

### CROSS-REFERENCE TO RELATED APPLICATIONS

This application is based upon and claims the benefit of priority from the corresponding Japanese Patent Application No. 2008-75113 filed on Mar. 24, 2008, the entire contents of which is incorporated herein by reference.

### FIELD OF THE INVENTION

The present invention relates to an image forming apparatus operable to print an image on an image forming medium.

### BACKGROUND OF THE INVENTION

There is an image forming apparatus furnished with a display for displaying a copy image showing how a scanned document image would be printed on a recording medium. For example, an operation unit having a copy-image confirming key and a copy-magnification adjusting key, and a structure for displaying a copy image which is a document image superimposed on a recording paper screen showing the recording paper in response to operation of the copy-image confirming key has been proposed. In this proposal, it has been further disclosed to change the display magnification factor of the document image in the copy image by operating the copy-magnification adjusting key and displaying again the changed copy image.

In the foregoing related art, an enlargement/reduction ratio is entered as a numeric value in order to make an enlarged/reduced copy of the document image. However, this method requires a preliminarily calculation of an appropriate enlargement/reduction ratio. This impedes the intuitive adjustment of enlargement/reduction of the document image.

In the foregoing related art, the document image is formed at a predetermined position on printing paper. Thus, the document image cannot be formed at a desired position on the printing paper. When the user wishes to make a reduced copy of the document image and to write comments in a place other than a document image frame, because the document image is formed in the place where the user wishes to write comments, the user must write comments somewhere else.

Furthermore, in the foregoing related art, even when the user wishes to make an enlarged/reduced copy of only a portion of the document image, such a copy cannot be made. Thus, when the user wishes to make an enlarged/reduced copy of only a portion of the document image, the user must cut out a desired portion using scissors or the like and then make an enlarged/reduced copy of the cut-out portion, which is bothersome.

### SUMMARY OF THE INVENTION

It is an object of the present invention to provide an image forming apparatus that can intuitively adjust an enlargement/reduction ratio of a document image and easily form an image at a desired position on an image forming medium.

An image forming apparatus according to an aspect of the present invention includes an operation unit that accepts an operation instruction; a print unit that prints a document image on an image forming medium in accordance with the accepted operation instruction; a print-preview-image generating unit that generates a print preview image of the document image; a display unit that displays on a display screen the print preview image of the document image, which is generated by the print-preview-image generating unit, and an image of a medium frame showing edges of the image forming medium, the print preview image being superimposed on the image of the medium frame; and a control unit that, when a print preview image frame of the document image displayed on the display screen is operated to be moved, enlarges/reduces the print preview image of the document image in accordance with an amount of movement of the print preview image frame and displays the enlarged/reduced print preview image.

The control unit superimposes the print preview image of the document image on the medium frame of the image forming medium and displays the print preview image superimposed on the medium frame on the display unit. When an operation instruction for moving the print preview image frame of the document image displayed on the display unit is given, the control unit enlarges or reduces the print preview image of the document image in accordance with the amount of displacement of the print preview image frame. Accordingly, the user can intuitively adjust the enlargement or reduction ratio of an image to be formed on the image forming medium. Also, the user can easily form an image at a desired position on the image forming medium by moving the print preview image frame of the document image. Additionally, only a desired portion of the document image can be easily enlarged or reduced, and an image thereof can be easily formed on the image forming medium.

Further features and specific advantages of the present invention will become apparent from the following description of exemplary embodiments.

### BRIEF DESCRIPTION OF THE DRAWINGS

FIG. 1 is a functional block diagram of a multi-functional peripheral (MFP) according to an embodiment of the present invention;

FIG. 2 is a flowchart showing an operation of the MFP according to an embodiment of the present invention;

FIG. 3A is a diagram showing a print preview screen of the MFP according to an embodiment of the present invention;

FIG. 3B is a diagram showing the result of image formation performed in accordance with a print preview image on the print preview screen shown in FIG. 3A;

FIG. 4A is a diagram showing the print preview screen of the MFP according to an embodiment of the present invention in the case where the lower right-hand corner of a print preview image frame is displaced in an upper leftward direction by performing a dragging and dropping of the pointing device;

FIG. 4B is a diagram showing the result of image formation performed in accordance with the print preview image on the print preview screen shown in FIG. 4A;

FIG. 5A is a diagram showing the print preview screen of the MFP according to the embodiment of the present invention in the case where the right side of the print preview image frame is displaced in an upper leftward direction by performing a dragging and dropping of the pointing device;

FIG. 5B is a diagram showing the result of image formation performed in accordance with the print preview image on the print preview screen shown in FIG. 5A;

FIG. 6A is a diagram showing the print preview screen of the MFP according to an embodiment of the present invention in the case where the lower right-hand corner of the print preview image frame is displaced in an upper leftward direction by performing a dragging and dropping of the pointing device;

FIG. 6B is a diagram showing the result of image formation performed in accordance with the print preview image on the print preview screen shown in FIG. 6A;

FIG. 7A is a diagram showing the print preview screen of the MFP according to an embodiment of the present invention in the case where the upper left-hand corner and the lower right-hand corner of the print preview image frame are displaced in an upper leftward direction by performing a dragging and dropping of the pointing device;

FIG. 7B is a diagram showing the result of image formation performed in accordance with the print preview image on the print preview screen shown in FIG. 7A; and

FIG. 8 is a diagram showing the print preview screen of the MFP according to another embodiment of the present invention.

### DETAILED DESCRIPTION OF EMBODIMENTS OF THE INVENTION

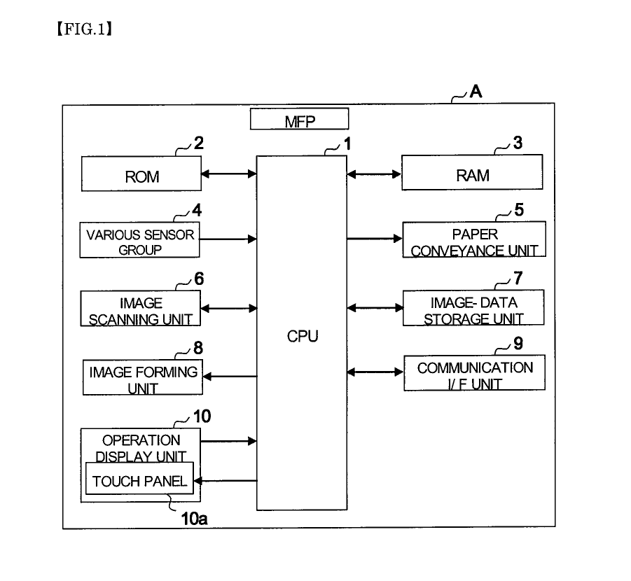

Hereinafter an embodiment of the present invention will be described with reference to the drawings. The following description concerns an MFP with a copy function and a print function, which is an exemplary image forming apparatus according to the present invention. FIG. 1 is a functional block diagram of an MFP A according to this embodiment. The MFP A includes a central processing unit (CPU) 1, a read-only memory (ROM) 2, a random-access memory (RAM) 3, a various sensor group 4, a paper conveying unit 5, an image scanning unit 6, an image-data storage unit 7, an image forming unit 8, a communication interface (I/F) unit 9, and an operation display unit 10.

The CPU 1 controls the overall operation of the MFP A on the basis of a control program stored in the ROM 2, document image data stored in the image-data storage unit 7, a print instruction input from an external device via the communication I/F unit 9, and an operation instruction input from the operation display unit 10. The details of a control process performed by the CPU 1 will be described as the operation of the MFP A below.

The ROM 2 is a non-volatile memory that stores the control program executed by the CPU 1 and other items of data.

The RAM 3 is a volatile memory used as a working area serving as a temporary data storage when the CPU 1 executes the control program and performs various operations.

The various sensor group 4 includes various sensors needed for an image forming operation, such as a paper-shortage detecting sensor, a paper-congestion detecting sensor, a paper-position detecting sensor, and a temperature sensor. Various items of information detected by the sensors are output as detection signals to the CPU 1.

The paper conveying unit 5 includes a conveyance roller for conveying printing paper stacked in a paper tray to the image forming unit 8, a motor for driving this conveyance roller, a conveyance roller for conveying the printing paper on which an image has been formed to an eject tray (not shown), a motor for driving this conveyance roller, and the like.

The image scanning unit 6 includes an automatic document feeder (ADF), a charge-coupled device (CCD) sensor, and the like. Images of documents sequentially fed by the ADF are scanned by the CCD sensor, and items of document image data based on the document images are output. The image scanning unit 6 outputs the document image data to the CPU 1, and the CPU 1 in turn stores the document image data in the image-data storage unit 7.

The image-data storage unit 7 is, for example, a flash memory. In response to a request from the CPU 1, the image-data storage unit 7 stores the document image data or outputs the document image data to the CPU 1. The image-data storage unit 7 additionally stores image data of a printing paper frame, which will be described later, and outputs the image data to the CPU 1.

Under control of the CPU 1, the image forming unit 8 transfers a print image formed by toner onto printing paper conveyed from the paper conveying unit 5 on the basis of the document image data stored in the image-data storage unit 7 and performs a process of fixing the print image.

The communication I/F unit 9 establishes a connection with an external device such as a personal computer (not shown) using a local area network (LAN) and sends/receives various signals to/from the external device.

The operation display unit 10 includes a start key for allowing a user to input a print instruction, a stop key for allowing a user to stop an image process currently being performed, a numeric keypad (numeric keys) for entering the number of prints, and various other operation keys. The operation display unit 10 further includes a touch panel 10a that is displayed as an operation screen and is used as an operation unit. The operation display unit 10 outputs operation instructions entered by operating the individual keys to the CPU 1. Under control of the CPU 1, the operation display unit 10 displays various screens, such as a print preview screen, on the touch panel 10a.

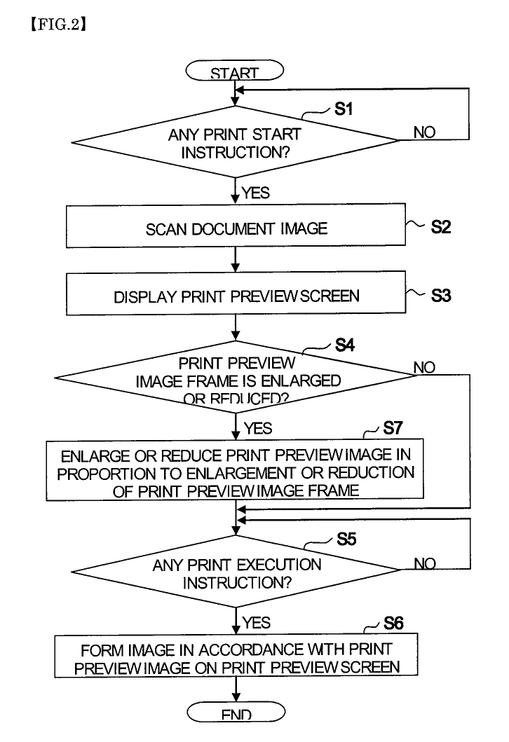

Next, the operation of the MFP A according to this embodiment, which has the foregoing structure, will be described in detail with reference to FIG. 2. FIG. 2 is a flowchart showing the operation of the MFP A according to this embodiment.

A user who wishes to make a copy of a document using the MFP A sets the document on the ADF and presses the start key included in the operation display unit 10.

The CPU 1 determines whether or not the operation display unit 10 has accepted a print start instruction entered by pressing the start key (step S1). When it is determined “no” in step S1, that is, when it is determined that the operation display unit 10 has accepted no print start instruction, the operation display unit 10 enters standby until the operation display unit 10 accepts a print start instruction.

When it is determined “yes” in step S1, that is, when it is determined that the operation display unit 10 has accepted a print start instruction, the CPU 1 causes the image scanning unit 6 to scan a document image of the document set in the ADF (step S2), generates data of a print preview screen on the basis of document image data input from the image scanning unit 6, and displays the print preview screen on the touch panel 10a (step S3). When displaying the print preview screen on the touch panel 10a, the CPU 1 superimposes a print preview image of the document image on a frame image of printing paper and displays the print preview image superimposed on the frame image. That is, when the CPU 1 receives information on printing paper based on printing conditions set on the operation display unit 10, the CPU 1 fetches from the image-data storage unit 7 printing-paper-frame image data or printing-paper image data for displaying the pseudo-edges of the printing paper, superimposes the print preview image on the printing paper, and displays the print preview image superimposed on the printing paper.

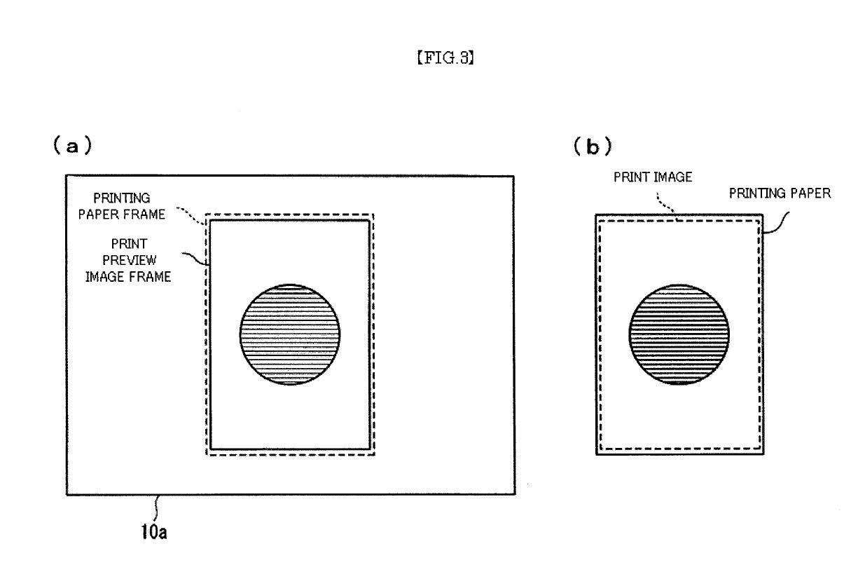

FIG. 3A is a diagram showing the print preview screen displayed on the touch panel 10a in step S3, and FIG. 3B is a diagram showing the result of image formation performed in accordance with the print preview screen. Referring to FIG. 3A, the print preview screen displayed on the touch panel 10a in step S3 will be described. As shown in FIG. 3A, the print preview screen displays a print preview image based on document image data, which is superimposed on an image of a printing paper frame showing the edges of printing paper. On the print preview screen in step S3, the edges of the printing paper frame and the edges of the print preview image (print preview image frame) are displayed at the same position. The print preview image frame is enlarged/reduced by performing a dragging and dropping operation. At this time, the printing paper frame is controlled not to respond to any dragging and dropping operations, and only the print preview image frame can be enlarged/reduced by performing a dragging and dropping operation of the pointing device. Note that the print preview screen displays a print execution button for accepting a print execution instruction in accordance with the current print preview image.

After step S3, the CPU 1 determines whether or not the print preview image frame on the print preview screen displayed on the touch panel 10a is enlarged/reduced by performing a dragging and dropping operation (step S4). When it is determined “no” in step S4, that is, when it is determined that the print preview image frame on the print preview screen has not been enlarged/reduced, it is determined whether or not the operation display unit 10 has accepted a print execution instruction entered by pressing the print execution button (step S5). When it is determined “no” in step S5, that is, when it is determined that the operation display unit 10 has accepted no print execution instruction, the operation display unit 10 enters standby until the operation display unit 10 accepts a print execution instruction. When it is determined “yes” in step S5, that is, when it is determined that the operation display unit 10 has accepted a print execution instruction, the CPU 1 causes the image forming unit 8 to form a print image on printing paper in accordance with the print preview image on the print preview screen displayed on the touch panel 10a (step S6).

Referring to FIG. 3B, the result of image formation performed in step S6 in accordance with the print preview image on the print preview screen shown in FIG. 3A will be described. FIG. 3B shows the result of image formation performed in accordance with the print preview image on the print preview screen shown in FIG. 3A. In image formation performed in accordance with the print preview image on the print preview screen shown in FIG. 3A, as shown in FIG. 3B, the edges of the printing paper coincide with the edges of the print image.

When it is determined “yes” in step S4, that is, when it is determined that the print preview image frame displayed on the print preview screen has been enlarged/reduced, the CPU 1 enlarges/reduces the print preview image in proportion to the enlarged/reduced ratio of the print preview image screen (step S7) and proceeds to step S5.

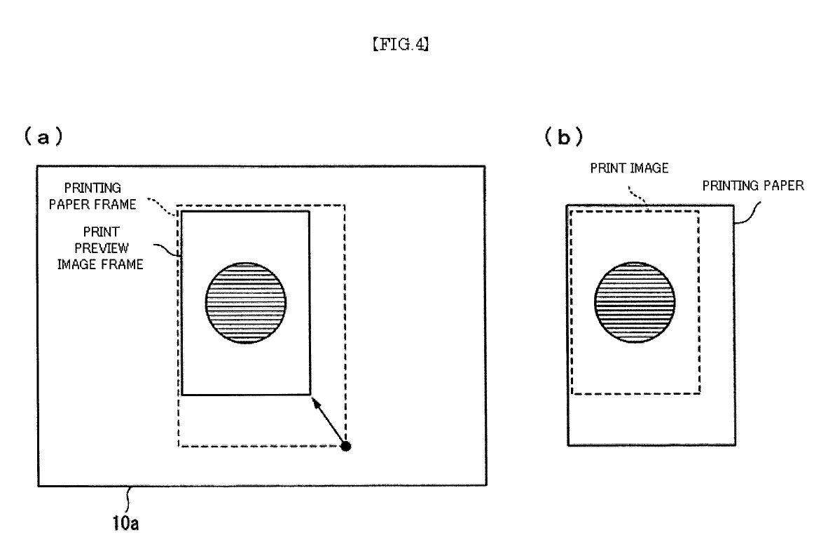

Step S7 and the print result obtained in step S6 in the case where the print preview image frame has been enlarged/reduced will be specifically described using FIGS. 4A, 4B, 5A, 5B, 6A, 6B, 7A, and 7B.

FIG. 4A is a diagram showing the print preview screen in the case where the lower right-hand corner of the print preview image frame is displaced in an upper leftward direction by performing a dragging and dropping operation of the pointing device, and FIG. 4B is a diagram showing the result of image formation performed in accordance with the print preview image on the print preview screen.

Specifically, FIG. 4A shows the print preview screen in step S7 in the case where the lower right-hand corner of the print preview image frame is displaced in an upper leftward direction by performing a dragging and dropping operation of the pointing device. FIG. 4B shows the result of image formation performed in accordance with the print preview screen shown in FIG. 4A.

As shown in FIG. 4A, when the lower right-hand corner of the print preview image frame is displaced in an upper leftward direction by performing a dragging and dropping operation of the pointing device, the print preview image frame is reduced at an equal ratio in the vertical direction and the horizontal direction. In step S7, the print preview image is reduced in the vertical direction and the horizontal direction in proportion to the reduction ratio of the print preview image frame. When image formation is performed in step S6 in accordance with the print preview image on the print preview screen shown in FIG. 4A, as shown in FIG. 4B, the print result is such that the print image is reduced at an equal ratio in the vertical direction and the horizontal direction, compared with FIG. 3B.

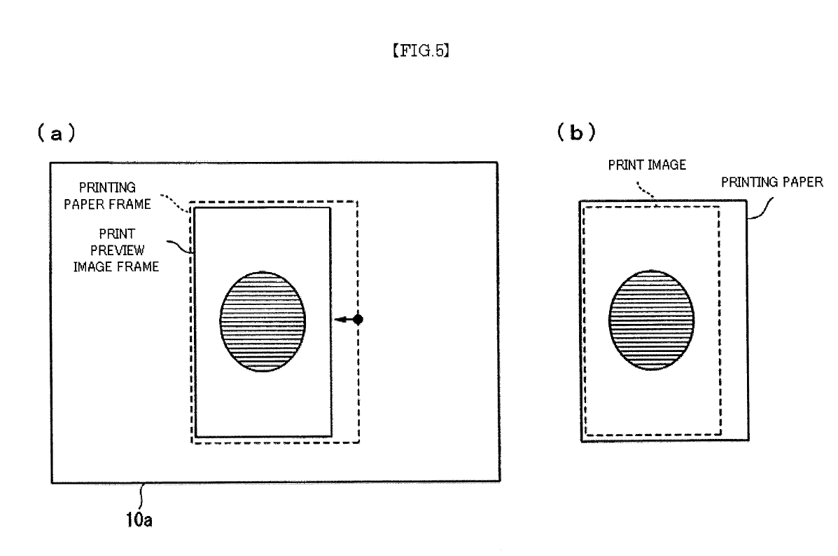

FIG. 5A is a diagram showing the print preview screen in the case where the right side of the print preview image frame is displaced in a leftward direction by a dragging and dropping operation of the pointing device, and FIG. 5B is a diagram showing the result of image formation performed in accordance with the print preview screen.

Specifically, FIG. 5A shows the print preview screen in step S7 in the case where the right side of the print preview image frame is displaced in a leftward direction by performing a dragging and dropping operation of the pointing device. FIG. 5B shows the result of image formation performed in accordance with the print preview screen shown in FIG. 5A.

As shown in FIG. 5A, when the right side of the print preview image frame is displaced in a leftward direction by performing a dragging and dropping operation of the pointing device, the print preview image frame is reduced in the horizontal direction. In step S7, the print preview image is reduced in the horizontal direction in proportion to the reduction ratio of the print preview image frame. When image formation is performed in step S6 in accordance with the print preview image on the print preview screen shown in FIG. 5A, as shown in FIG. 5B, the print result is such that the print image is reduced in the horizontal direction, compared with FIG. 3B.

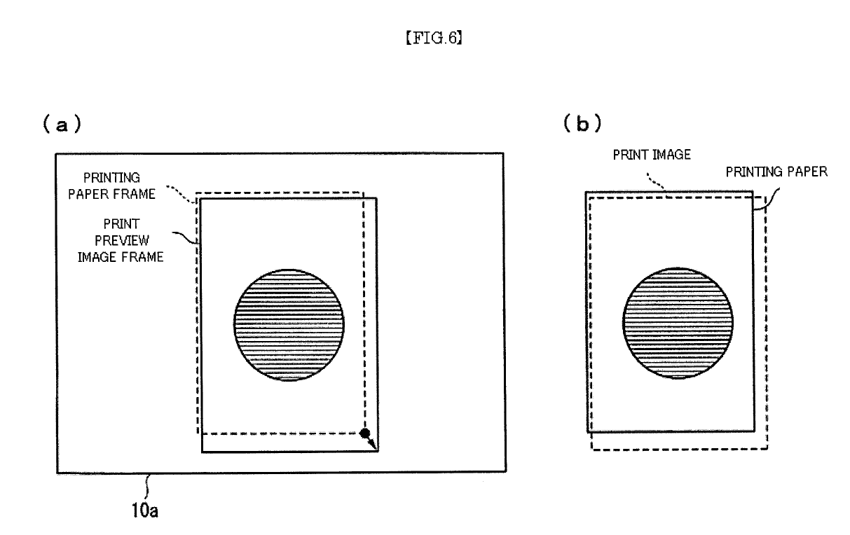

FIG. 6A is a diagram showing the print preview screen in the case where the lower right-hand corner of the print preview image frame is displaced in a lower rightward direction by performing a dragging and dropping operation of the pointing device, and FIG. 6B is a diagram showing the result of image formation performed in accordance with the print preview image on the print preview screen. Specifically, FIG. 6A shows the print preview screen in step S7 in the case where the lower right-hand corner of the print preview image frame is displaced in a lower rightward direction by performing a dragging and dropping operation of the pointing device. FIG. 6B shows the result of image formation performed in accordance with the print preview screen shown in FIG. 6A.

As shown in FIG. 6A, when the lower right-hand corner of the print preview image frame is displaced in a lower rightward direction by performing a dragging and dropping operation of the pointing device, the print preview image frame is enlarged at an equal ratio in the vertical direction and the horizontal direction. In step S7, the print preview image is enlarged in the vertical direction and the horizontal direction in proportion to the enlargement ratio of the print preview image frame.

When image formation is performed in step S6 in accordance with the print preview image on the print preview screen shown in FIG. 6A, as shown in FIG. 6B, the print image is enlarged at an equal ratio in the vertical direction and the horizontal direction, compared with FIG. 3B. Since regions at the right edge and the bottom edge of the print image protrude from the printing paper, these regions are not printed on the printing paper.

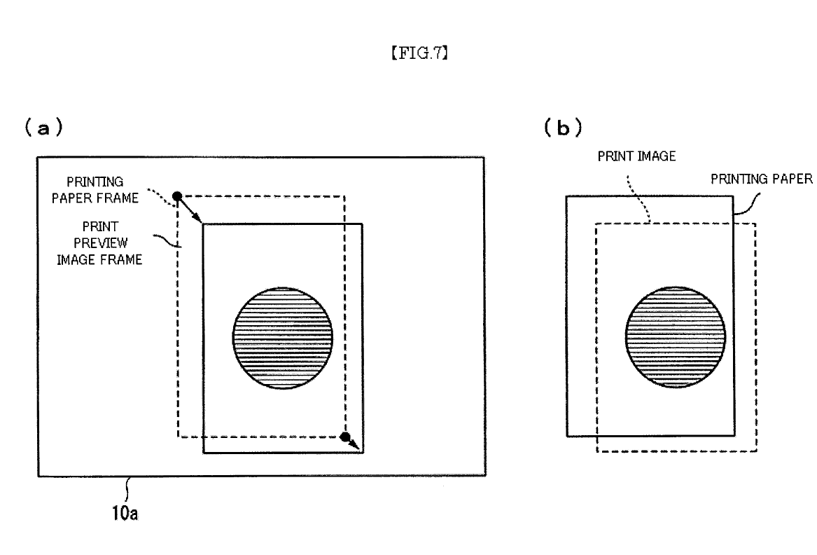

FIG. 7A is a diagram showing the print preview screen in the case where the upper left-hand corner and the lower right-hand corner of the print preview image frame are displaced in a lower rightward direction by performing a dragging and dropping operation of the pointing device, and FIG. 7B is a diagram showing the result of image formation performed in accordance with the print preview image on the print preview screen.

Specifically, FIG. 7A shows the print preview screen in step S7 in the case where the upper left-hand corner and the lower right-hand corner of the print preview image frame are dragged in a lower rightward direction. FIG. 7B shows the result of image formation performed in accordance with the print preview image on the print preview screen shown in FIG. 7A.

As shown in FIG. 7A, when the upper left-hand corner and the lower right-hand corner of the print preview image frame are displaced in a lower rightward direction by performing a dragging and dropping operation of the pointing device, the print preview image frame is reduced at an equal ratio in the vertical direction and the horizontal direction due to the movement of the upper left-hand corner in the lower rightward direction. At the same time, the print preview image frame is enlarged at an equal ratio in the vertical direction and the horizontal direction due to the movement of the lower right-hand corner in the lower rightward direction. That is, in step S7, the entire print preview image is similar to being moved in the lower rightward direction.

When a image formation is performed in step S6 in accordance with the print preview image on the print preview screen shown in FIG. 7A, as shown in FIG. 7B, the print result is such that the entire print image is similar to being moved in the lower rightward direction, compared with FIG. 3B. A print start position in the upper left-hand corner of the print image is moved in the lower rightward direction, compared with FIG. 3B. Regions at the right edge and the bottom edge of the print image protruding from the printing paper are not printed on the printing paper.

As above, in the MFP A according to the embodiment, the CPU 1 displays a printing paper frame and a print preview image on a print preview screen on the touch panel 10a, and a print preview image frame is enlarged/reduced by performing a dragging and dropping operation of the pointing device, whereby the print preview image is enlarged/reduced. Accordingly, the user can intuitively adjust the enlargement/reduction ratio of a print image to be formed on printing paper. Also, the user can easily form an image at a desired position on printing paper by enlarging/reducing the print preview image frame by performing a dragging and dropping operation of the pointing device. Additionally, only a desired portion of a document image can be easily enlarged/reduced, and an image thereof can be easily formed on printing paper.

Although an exemplary embodiment of the present invention has been described above, the present invention is not limited thereto. For example, the following modifications are conceivable.

(1) Although the print preview image frame is enlarged or reduced by performing a dragging and dropping operation of the pointing device in the foregoing embodiment, the present invention is not limited thereto. For example, the print preview image frame may be enlarged/reduced by operating a direction key on the operation display unit 10.

(2) Although a print start instruction in response to pressing the start key is accepted and then the print preview screen is displayed on the touch panel 10a in the foregoing embodiment, the present invention is not limited thereto. For example, a key for performing print preview display may be provided in the operation display unit 10, and the print preview screen may be displayed in response to pressing this key. In order to display a print preview image of a document set on the ADF, the image scanning unit 6 is controlled to scan a document image in response to pressing the foregoing key, and a print preview screen is displayed on the touch panel 10a.

(3) Although the MFP A includes an operation display unit 10, the present invention is not limited thereto. For example, a second operation display unit may be coupled with the MFP and the print preview screen may be displayed on the second operation display unit.

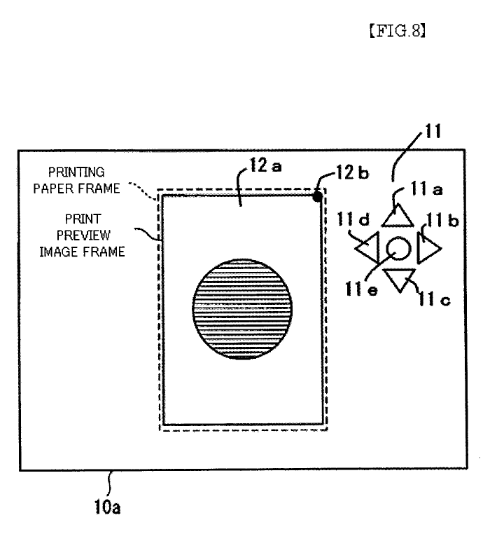

FIG. 8 is a diagram, that illustrates the foregoing modification (1), showing a touch panel of an MFP according to a second embodiment of the present invention. This embodiment differs from the foregoing first embodiment in operations relating to the print preview image frame of the MFP A. The same reference numerals are given to common components.

Referring to FIG. 8, the print preview screen displayed on the touch panel 10a displays a direction switch 11 together with a print preview image 12a. The direction switch 11 includes an upward switch 11a for giving an upward operation instruction, a rightward switch 11b for giving a rightward operation instruction, a downward switch 11c for giving a downward operation instruction, and a leftward switch 11d for giving a leftward operation instruction. The direction switch 11 further includes a confirmation key 11e for confirming an operation instruction. The confirmation key 11e is surrounded by the direction switches 11a to 11d. When the print preview screen is displayed, a pointer 12b is displayed at a predetermined position on the print preview image 12a. The position at which the pointer 12b is displayed is determined by an initial setting.

The pointer 12b moves to the corner or the side of the print preview image frame by operating the direction switches 11a to 11d. For example, when the downward switch 11c is pressed in the state shown in FIG. 8, the pointer 12b moves to the right side of the print preview image frame. When the downward switch 11c is further pressed, the pointer 12b is moved to the lower right-hand corner of the print preview image frame. When the upward switch 11a is pressed thereafter, the pointer 12b is moved to the right side of the print preview image frame. Operations are not limited to the above operations. When any of the direction switches 11a to 11d is continuously pressed, the pointer 12b may be continuously moved along the print preview image frame in the clockwise or counterclockwise direction. When the pointer 12b is operated to press the confirmation key 11e, a reference point for deforming the print preview image is confirmed, and the pointer 12b is fixed on the print preview image frame. When any of the direction switches 11a to 11d is pressed, the print preview image is enlarged/reduced in accordance with the direction of the pressed direction switch. For example, when the confirmation key 11e is pressed in the state shown in FIG. 8 and then the rightward switch 11b is pressed, the print preview image frame is extended in the horizontal direction, and accordingly, the print preview image is deformed. When the upward switch 11a is pressed thereafter, the print preview image frame is extended upward, and accordingly, the print preview image is deformed. In such a manner, when the pointer 12b is placed in any of the corners of the print preview image frame and is positioned, the print preview image can be enlarged/reduced in both the vertical and horizontal directions. When the pointer 12b is placed on any of the sides of the print preview image frame and is positioned, only that side can be operated and moved.

Although the direction switch 11 is displayed on the touch panel 10a in the foregoing embodiment, the direction switch 11 may be provided as a push-button switch in an area different from the touch panel 10a on the operation display unit 10.

From the foregoing embodiments, the present invention is summarized as below. That is, an image forming apparatus according to an embodiment of the present invention adopts an image forming apparatus including an operation unit that accepts an operation instruction; a print unit that prints a document image on an image forming medium in accordance with the accepted operation instruction; a print-preview-image generating unit that generates a print preview image of the document image; a display unit that displays on a display screen the print preview image of the document image, which is generated by the print-preview-image generating unit, and an image of a medium frame showing edges of the image forming medium, the print preview image being superimposed on the image of the medium frame; and a control unit that, when a print preview image frame of the document image displayed on the display screen is operated to be moved, enlarges/reduces the print preview image of the document image in accordance with the amount of displacement of the print preview image frame and displays the enlarged/reduced print preview image.

The image forming apparatus may further include a print-preview-image-data storage unit that stores data of the print preview image. The print-preview-image generating unit may generate a print preview image on the basis of the image data stored in the print-preview-image-data storage unit and the operation instruction.

The image forming apparatus may further include an image scanning unit that scans the document image. The print-preview-image generating unit may generate a print preview image of the document image scanned by the image scanning unit.

The operation unit may further include a pointing device that gives an instruction of coordinates on the display screen of the display unit. When the print preview image frame is enlarged/reduced by a dragging and dropping of the pointing device, the control unit may enlarge/reduce the print preview image in accordance with the amount of movement of the print preview image frame and display the enlarged/reduced print preview image.

The operation unit may further include a direction instruction key for giving an instruction of a direction on the display screen of the display unit and an amount of displacement instruction key for giving an instruction of the amount of displacement. When operation instructions of the direction and the amount of displacement of the print preview image frame are given using the direction instruction key and the amount of displacement instruction key, the control unit may enlarge/reduce the print preview image in accordance with the direction and the amount of displacement of the print preview image frame and display the enlarged/reduced print preview image.

Although the present disclosure has been described in relation to particular embodiments thereof, many other variations, modifications, combination of features, and other uses will become apparent to those skilled in the art. It is preferred, therefore, that the present disclosure be limited not by the specific disclosure herein, but only by the appended claims.

What is claimed is:

1. An image forming apparatus operable to print an image on an image forming medium, the image forming apparatus comprising:
an operation unit operable to accept an operation instruction;
a printing unit operable to print a document image on the image forming medium in accordance with the accepted operation instruction;
a print-preview-image generating unit operable to generate a print preview image based on the document image;
a display unit including a display screen and operable to display on the display screen the print preview image generated by the print-preview-image generating unit, and an image of a medium frame showing edges of the image forming medium, the print preview image being displayed as superimposed on the image of the medium frame; and
a control unit operable, when a print preview image frame displayed on the display screen is moved, to enlarge/reduce the print preview image of the document image in accordance with an amount of displacement of the print preview image frame and to display the enlarged/reduced print preview image on the display screen.

2. The image forming apparatus according to claim 1, further comprising a print-preview-image-data storage unit operable to store image data comprising the print preview image,
wherein the print-preview-image generating unit is operable to generate a print preview image on the basis of the image data stored in the print-preview-image-data storage unit and the operation instruction.

3. The image forming apparatus according to claim 1, further comprising an image scanning unit operable to scan the document image,
wherein the print-preview-image generating unit generates the print preview image based on the document image scanned by the image scanning unit.

4. The image forming apparatus according to claim 1, wherein the operation unit further includes a pointing device operable to provide an instruction of coordinates on the display screen of the display unit,
wherein the print preview image frame is enlarged/reduced in accordance with a dragging and dropping operation of the pointing device, and the control unit is operable to enlarge/reduce the print preview image in accordance with the amount of displacement of the print preview image frame and to display the enlarged/reduced print preview image.

5. The image forming apparatus according to claim 1, wherein the operation unit further includes a direction instruction key for giving an instruction of a direction on the display screen of the display unit and an amount of displacement instruction key for giving an instruction of the amount of displacement,
wherein operation instructions of the direction and the amount of displacement of the print preview image frame are given using the direction instruction key and the amount of displacement instruction key, and the control unit is operable to enlarge/reduce the print preview image in accordance with the direction and the amount of displacement of the print preview image frame and to display the enlarged/reduced print preview image.
